(19) United States
(12) Patent Application Publication
(10) Pub. No.: US 2009/0092134 A1
(43) Pub. Date: Apr. 9, 2009

(54) Method for Geolocation based on the unique identifier information of an electronic device detected by the first router in a network connection

(76) Inventor: Sebastian Ignacio Herrera Schuvab, Buenos Aires (AR)

Correspondence Address: Sebastian Ignacio Herrera Schuvab, 2185 Fray Santamaria de Oro 2185 1B, Buenos Aires, 1425, AR

(21) Appl. No.: 12/244,770

(22) Filed: Oct. 3, 2008

Related U.S. Application Data
(60) Provisional application No. 60/977,716, filed on Oct. 5, 2007.

(51) Int. Cl. H04L 12/56; H04L 9/32; G06Q 50/00; G06Q 20/00

(52) U.S. Cl. 370/389; 726/27; 705/400

(57) ABSTRACT

A system to determine the geographical location of an origin electronic device with networking capabilities, based on the information provided by data carrier companies. Each company assign to geographic coordinates their last mile connections. In the communications between two machines located in different Local Area Network, data packets show the following characteristics:

IP addresses within the IP Header will show the same values from the origin machine to the destination machine.

Physical Addresses will be modified whenever the package of Information makes a hop in a router, modifying the unique identifier pair that composes the package of information.

The system compares the pair of unique identifiers for a package with the same logical addresses, transmitted by all routers from carriers affiliated to the system, detecting which one was the first router with direct communication with the origin unique identifier. The system communicates geographical positions to content provider companies.

### CROSS-REFERENCE TO RELATED APPLICATIONS

This application claims Benefit of U.S. Provisional 60/977,716, filed Oct. 5, 2007, the entire contents of which is incorporated herein by its reference.”

### FIELD OF THE INVENTION

This invention relates generally to techniques of geographic location of electronic devices with networking capabilities, using a network of routers-gateways. More particularly, it relates to a method of electronic device detection, based on a system that analyzes the information received, to detect the first pair of physical addresses on a data packet communication between computers. This network of devices, their respective geographic locations and the pair of physical addresses, presented in a communication between two devices, provides the chance to create a geo location system. This system has an average precision range from 10 meters to 800 meters, with a maximum estimated range of 10 miles. This system has the possibility to incorporate and geographically locate telephone based connections, wireless connections and cellular network connections. The present method shows an important utility for content and data carrier companies. For content provider companies, offering them the possibility to customize content for a particular unique identifier in a precise geographic coordinates all over the world. This information includes content such as, but not limited to, web information systems and audiovisual content, for their diffusion, promotion and sale. For data carrier companies, the possibility to receive an economic benefit for each geo located package transmitted to the network and paid by a content company.

### BACKGROUND OF THE INVENTION

This invention takes in consideration concepts such as last mile Internet access and network operating standards to develop a Geolocation system. This Geolocation system will provide the possibility to customize content for particular electronic device with network capabilities, with a precision defined in degrees, minutes and seconds of geographic coordinates in the entire world.

Current Geolocation systems are less precise when they try to estimate the geographic position of electronic devices with a range of precision beyond the country as a whole. Geolocation systems can estimate the geographic location of an electronic device with a 99% of accuracy for country analyses. But this number decrease to 60-65% when they try to estimate that location with a higher range of precision such as a city or postal code. In the present situation, Geolocation companies recollect information from all over the Internet using collection points, analyzing up to 1.4 billions of IP Addresses to detect the geographic location of an electronic device requesting information. These companies use large quantities of mathematic calculations, track network changes and collect of information from all over the internet to support their operations. These companies use an outside inside approach; by this we mean that they focus on the whole system to detect a particular IP address Geolocation.

Current Geolocation based on IP address detection can be enhanced. Data carrier companies have the possibility to know the geographic locations of their last mile access. Knowing the geographic location of the access, make it possible to customize content for electronic devices with network capabilities, with a precision in meters. This is possible based on the way information network works. Since the creation of the information networks, computers have been sending and receiving data packages to communicate between them. Using the Open Systems Interconnection Basic Reference Model, OSI Model, to explain the technical side, in a communication between two machines:

The Third Layer, defined as network,: will be responsible for assigning IP Addresses, Logical Addresses, to the data packages being part of the connection.

The Second Layer, defined as Data Link,: will be responsible for communicating physical addresses of the related machines.

These are only a few functions of each layer, but in these functions lie the explanation and logic of the system.

Logical addresses are assigned by the network administrator in a particular moment.

These addresses can be assigned as fixed for a particular computer, or randomly using DHCP, meaning Dynamic Host Configuration Protocol. It is a common situation to observe among data carrier companies, a random assignment of IP Addresses in the machines connecting to their network. Despite that nowadays the proliferation of ADSL connections generate one IP address available for each connection offered to users, the reality shows that this method will continue based on two facts:

From a technical side: using random assignation of IP address, data carrier companies are managing load of data balance received from their customers.

From a commercial side: assigning a fixed IP address makes possible for customers to run fixed services such as web pages. Using DHCP this is not possible. Data carrier companies like ISP are very costly, compared with the cost of an ADSL connection, for these kinds of services.

For these two reasons we believe that in the future, even if they have the numeric possibility to assign each device a fixed IP Address with IPV6, data carrier companies will remain using the DHCP system.

Physical addresses are unique identifiers assigned to a particular network adapter. These numbers are assigned by the Institute of Electrical and Electronic Engineers to each vendor. Every network card has a unique identifier called MAC address with a 48-bit serial number. These two types of addresses, logical and physical, plus the transport layer using TCP as the most common protocol in the internet, will allow machines to pack their data and communicate to other computers.

In a communication between two computers inside a Local Area network, such as IEEE 802.1 Ethernet configuration, both machines will communicate directly to the other. Machines will know both addresses, logical and physical, of all other networks within the same LAN. For more practical purposes switch and hubs are electrical repeaters or smart repeaters, but they don't perform Hops like routers do. Switch and hubs don't change the physical address of a data package sent inside the LAN. Consequently, all data packages inside a LAN maintain in a communication from one computer to the other, the same pair of Logical and Physical addresses.

This situation varies when we incorporate other devices located in different Local area networks. To communicate these devices, networks will use routers. Routers are totally different from switches or hubs, these equipments modify the information contained in a data package on a physical level, changing the pair of physical addresses contained through router to router. Data packages communicating two machines located in different LANs maintain at a layer level 3, network, the same pair of logical address with Origin IP source and Destination IP source, from one computer to the other. On the other hand, at a layer 2, defined as Data Link, physical address pairs will be modified on each Hop that the package performs on each router.

Consequently, destination machines will know the logical address of origin devices but the physical layer of the last router. The only machine that knows the first pair of physical unique identifiers, such as MAC address, will be the first router connecting with the origin computer.

The way Internet works nowadays, allows data carrier companies, if they geographically locate their last mile connections, to detect and know the physical address of an electronic device requesting information. Only data carrier companies being the first router will know the geo location of electronic devices with network functionalities requesting information and connecting to the Internet, with a precision of geographic coordinates. Assigning last mile connections to geographic coordinates it is possible based on the proprietary information that data carrier companies have. Data carrier companies using telephone, wireless and cellular connections control the last mile access to the network and first router. This makes possible only for them to know the first pair of unique identifiers enrolled in a communication transaction, defined as layer 2 Data Link, physical address. This geographic location it is possible based on the precision of Geolocation software, and the proprietary information that data carrier companies have.

Each company can assign to geographic coordinates their last mile connections: In the case of telephone connections, these companies receive their connections directly from their customers fixed telephone lines. When those customers connect to the ISP, companies know the telephone line accessing to their network. Data carrier companies make a match using the Username and password of those users and assign a logical public address to surf the internet.

Taking in consideration fixed telephone lines are installed in homes and businesses, it is possible for data carrier companies to match that information with the Geolocation software to assign geographic coordinates to those last mile access. Assigning the fixed lines to geographic coordinates, data carrier companies can provide information of the location of particular electronic device accessing to the internet. When we analyze Cellular networks, we see that these systems develop their operations using a network of Antennas covering different locations in a certain geographic area, providing mobile devices with access to their networks. At an operating level, those companies assign antennas and their cells to base station subsystems. Through this mechanism cellular networks can manage their flow of packages—voice or data—in their networks. Data packages are channeled towards the Server GPRS support node. These machines manage:
Route and data package transfer.
Location information, current cell and VLR.
Users profiles, using IMSI or TMSI.

From the Server GPRS support node, data packages go through the Gateway GPRS support node. These machines convert GPRS packages into the appropriate data package format for the internet. GGSN acts as an interface between SGSN and external networks such as IP networks or radio networks.

A system with these characteristics can accept identifier mobile subscriber identity or temporary mobile subscriber identity information from Cellular companies. Each company will decide which information they want to transfer to the system. Most of carriers prefer to communicate information using temporary mobile subscriber identity to protect unique identifiers. Two methods are the common standard among companies, Cell identification and Assisted GPS. Each Cellular Data Carrier company will decide the system that they will use. The method selected will impact in the range of precision of the geographic location transmitted to the system.

Finally, regarding Wi Fi companies, all the electronic equipment accessing those networks carries W-LAN devices, which has a unique identifier attached, called a MAC address. When these devices detect a signal, they generate a connection and the accessing machine assigned a private IP Address.

At an operating level in the Wireless industry, it is common to observe three situations:
ISP companies, operating with telephone connections offer their consumers, wireless routers, IEEE 802.11, to create wireless environments in their homes. In this case the first router will be the one managed by the ISP Company.
Wi Max data carrier companies, IEEE 802.16, giving access to consumers using Antennas with an important range of coverage—between 0 meters to 10000 meters—
Wi Fi companies, IEEE 802.11, offering Wi Fi routers to their communities, where the benefit resides in the idea to give and receive free or paid, Wi Fi access. In this case, Wi Fi routers operated by Wi Fi community companies acts between the customer and their Data Carrier company. Despite the fact that they are not going to assign the public IP address, these companies will handle and administer the first pair of physical addresses, being the first router between a consumer and the internet.

Comparing a system with these characteristics with current methods of Geolocation, we can infer that the proposed scheme brings some interesting characteristics and advances for participants:
Data carrier companies receive an economic retribution for all geographically located packages transmitted to and paid for by content provider companies affiliate to the system.
Content provider companies will be able to deliver customized content for a particular electronic device in a particular geographic position.
The system changes the present approach analyzing the network from the inside to the outside. By this we mean, data carrier companies informed their network configurations and geographical positions of their last mile accesses.

The system provides a systemic approach for all Internet participants. In the present situation content provider companies duplicate on daily basis the amount of technical, infrastructure and bandwidth necessities that that their solutions need to operate. Typical high demanding solutions are video and television on demand platforms, top search engines and rich media content offered through their systems. These companies earn lots of money each quarter based on these developments and the advertising revenue generated by their platforms.

On the other hand, data carrier companies have to raise the bar increasing and duplicating their infrastructures to serve their consumers, receiving the same economic pay from their users and no economic retribution from the content providers companies.

That it is why the system offers a novelty approach for all participants. Through the system, data carrier companies receive an economic benefit for each geographically located package that they transmitted to and a content provider company paid for. This income contributes to increased investments in networking, expanding the present infrastructure. If they have a greater network, they will receive more money for each geographically detected connection that they generate, obtaining greater benefits for their operations.

From the content provider's side, the system provides geographically detected data packages of information. Content provider companies that need Geolocation information with the current level of precision use the current systems and pay nothing to data carrier companies. Content provider companies requesting a Geolocation system with a higher precision of geographic coordinates pay to data carrier companies for the information provided. The system appears as the best method, data carrier companies receive an economic benefit for the offered information, information that is only possible to be generated by their contribution being the primary access to the internet and having access to the first pair of unique identifiers.

The possibility to customize content for a particular geographic location gives content provider companies the chance to enhance the present situation in systems such as:
Search engine content, assigned for particular electronic device with a higher level of precision, based on the geographical information provided by the Data Carrier Company.
IP address and unique identifier validation for online payment of gateways, decreasing online fraud.
Ad serving with a higher level of precision, with the possibility to incorporate local advertising to the served results.
Online classified providing consumers with access to products that are located within a range of geographic precision

In audiovisual systems:

Digital rights management: for premium content like movies or music. With the proposed system, premium content can be approved for distribution based on a particular location area.

The proposed system method gives the chance to understand a last mile connection like a unique point of information in any place of the world. This point of information have a past and a present giving people accessing the internet from that geographic coordinates, the possibility to receive customized content from audiovisual platforms, web information services, advertising and products.

### SUMMARY

The method for the customization of contents based on the geographic location of an electronic device with networking capabilities, takes concepts available in communications of packages in the Internet, to develop a system of geo location. This Geolocation system will allow serving customized contents with a precision level of geographical coordinates expressed in degrees, minutes and seconds, covering the entire world.

This system is possible based on the constitutive characteristics of the information networks. TCP/IP Is the common protocol of Internet. It provides all the necessary services for the transport of data. Data packages travel encapsulated between the hardware protocols used for communications. Therefore, it is possible to say that in the communications between two machines located in different Local Area Network, the following characteristics will be observed:
IP addresses (layer 3 network) within the IP Header will remain without changes from the origin machine to the destination machine. Origin IP address and destination IP address will be always the same in the entire route from one machine to the other.
Physical Addresses (Layer 2 Data link) will be modified whenever the package of Information makes a hop in a router, modifying the MAC address pair that composes the package of information.

This modification will change the origin MAC address pair on each hop performed by the data packet in a router. The physical addresses will be replaced by the MAC address of the equipments operating on that route. Consequently, a data packet will carry the same logical address in the entire route, but different physical layer on each frame defined by routers. Beginning with the premise that Data carrier companies can incorporate deep packet inspection techniques and assign their last mile connections to geographic coordinates:
Any primary access equipment can be assigned in a geographical coordinate. Knowing the location of that equipment, the location of electronic device with networking capabilities, can be known.
Any package of information generated and inspected by using deep packet inspection techniques, from the origin device to the first router, will bring built-in at layer 2 levels, the pair of MAC address of the equipments that takes part of the connection. Knowing the geo location of the last mile access equipment, will allow the system to know where the origin electronic device with networking capabilities is located, and the geographical coordinates that represents this particular point in the world.

For the system it is important to have the logical and physical addresses operating in that particular connection. Geolocation can be made using only the logical address plus the geo location provided by the Data Carrier Company, but the possibility to have the physical address makes it possible to know if that it is the first router in the network. The system will compare all the information provided by different networks, if a router communicates as the first MAC address a unique identifier communicated by another router as the second MAC address, our system will understand that the second one is the very first router in that route between the origin machine and the destination machine.

On the other hand, assigning physical addresses will let us give access to a particular computer, and not to all the computers connected to that access point. If we provide access to premium content to a logical address, IP address, all the devices attached to that public IP address will have access to that content. As an example, giving permission to a logical address will give:
In an ADSL connection, access to one machine.
In a Wi Fi connection, access to all the devices attached and connected in a range of 0 mts to 100 mts average.
In a Wi Max or Cellular connection, access to all the devices attached and connected in a range of 0 mts to 10000 mts maximum.

That is the reason why the system needs to know Origin IP Address, Destination IP Address, Latitude and Longitude expressed in degrees, minutes and seconds, MAC address pair on that part of the route. Unique identifier 1 and MAC address 2. The system takes into consideration the geographic location generated by the first section of the connection, between the MAC address of the origin device, and the MAC address of the first router that receives the information. The first router will be the only device in the network with access to the first pair of physical addresses. All other Routers receiving the data package will have the physical addresses of intermediate machines in the network.

Given to the proposed model of Geo Location, the system will show the following characteristics and participants:
Data carrier companies will continue to inform, in real time, the geographic positions of the electronic devices that are accessing the Internet. These companies will offer that information with the idea to obtain an economic benefit based on the geographic information offered, and the amount of packages transmitted towards those affiliate content platforms.
Content provider companies affiliated with the system, which paid to receive the information of the geographic location of the origin electronic equipments.
A centralized system which will estimate the value per package, geographically located and transmitted, to pay by Data carrier companies. This estimation will be based on the geographic characteristics from where that package of information has been generated.

At an operating level the system begins providing data carrier companies, such as ISP, Wi Fi and Cellular networks, with access to geographic location software to determine the geographical position of their last mile access connections. Through this software, data carrier companies are able to geographically locate their connections with a precision expressed in degrees, minutes and seconds covering the entire world.

Each Data Carrier company will define:
Wireless companies: the geographic location of equipment that is part of their network. We refer to equipment such as Wi Max antennas or Wi Fi routers.
Telephone connection companies, such as ADSL connections: the geographic location of fixed telephone lines and the addresses of their customers.
Cellular networks: the geographic location of the BTS, Antennas, which are part of their reception network.

Data carrier companies will upload information on real time to the system of data packets with geographic location. It is important to clarify that the privacy of customers inside each company is protected. Data carrier companies do not transmit proprietary information about their customers to the system. The system receives only the information of electronic devices with networking functionalities, accessing the internet from a particular location. Data carrier companies upload information based on: Origin IP address, Destination IP address, Geographic location expressed in Latitudes and Longitudes, Unique identifier1 and unique identifier2.

Taking into consideration that DHCP is the common operating procedure to assign a logical address to electronic device, it is clear that the same IP address will appear in different frames of time:
Different Geographic locations.
Different Unique Identifiers 1 and 2.

In the case of Cellular networks, the system takes into consideration the IMSI or TMSI information as the first unique identifier in the pair communicated to our system. The system will receive as the pair of unique identifiers, the TMSI information and the Mac address 2 of the first computer acting as router of packages. As TMSI are temporary unique identifiers, cellular networks communicating TMSI to the system will be responsible for adjusting the information each time their system changes the temporary identifier.

Current Geolocation system varies among carriers. The system will assign data carrier companies to a rate scale based on the registration information and daily operations performed by these participants. The rate scale assigned to a company will depend on:
Amount of GB transmitted per month, where more volume means to receive more money.
Market share based on IP address: the relation between the amount of IP addresses that the Data Carrier company has, compared with the total amount of IP addresses from the same location uploaded by data carrier companies' affiliates to the system in that place. Where more technological infrastructures means to receive more money.
Market Share Mac Address: the relation between the amount of MAC addresses that the Data Carrier company transmitted to the system in a certain period of time, compared with the total amount of MAC addresses transmitted from the same location uploaded by data carrier companies affiliate to the system in that place in the same moment. Where more unique devices transmitted receives more money.
Range precision: the range precision that this Data Carrier Company shows based on the selected method of connection. Where more precisely geographic location transmitted to the system means to receive more money.

The system compares the pair of MAC addresses for a package with the same logical addresses, transmitted by all routers from data carrier companies affiliated to the system, detecting which was the first router with direct communication with the origin unique identifier. At the same time, content provider companies make their affiliation to the system and determine the markets where they want to be enrolled. The system offers content provider companies with high traffic volume, a table with IP ranges based on country affiliations that they made. Subscribing to a country means to accept the cost per package estimated by the system. If the origin logical address received by the content provider companies doesn't belong to a Country of affiliation, the Web services response will be “Not part of your affiliate zone”. On the other hand, if the logical address belong to a country were the content company was affiliated, the system will provide the information of Geographic localization of the origin electronic device. Finally, the system pays the data carrier company for the geographically located package, if data has been purchased by the destination content company.

The system can act as a content approval platform. Users enrolled in this particular system, allow the system Software to manage permissions. This software operates independently from the geo location system. But the Geolocation system is the one that informs the content provider company the physical addresses of the requestor device to be approved based on his geographical location. Content providers companies detect the user geographic location and approve/or deny a user request of content. If approved, that decision is forwarded to the system, Content providers companies redirect users to the system gateway. The system opens a secure connection using TLS protocols and act as a third party between the user and the content provider company. The system compares the unique identifier informed by the content provider company with the unique identifier communicated by the software. On the other hand, users with the software of content delivery installed will be transmitting to the system the physical and logical addresses of their electronic devices. The system matches the physical address communicated with the physical address approved by the content provider company. If it is correct the content is delivered. Otherwise the content is blocked. By using this platform content companies know, that they are sending the information to the correct unique identifier. The system is validating that connection and the software is providing the correct content to a unique user. On the other hand, users can set their own account at the system, paying for all premium content delivered by content provider companies affiliated with the system, in one source.

### BRIEF DESCRIPTION OF THE DRAWINGS

FIG. 1: TELEPHONE NETWORK/WI FI NETWORK GEOLOCATION AND DATA TRANSFER, using the system Geolocation software to geographically locate their last mile connections.

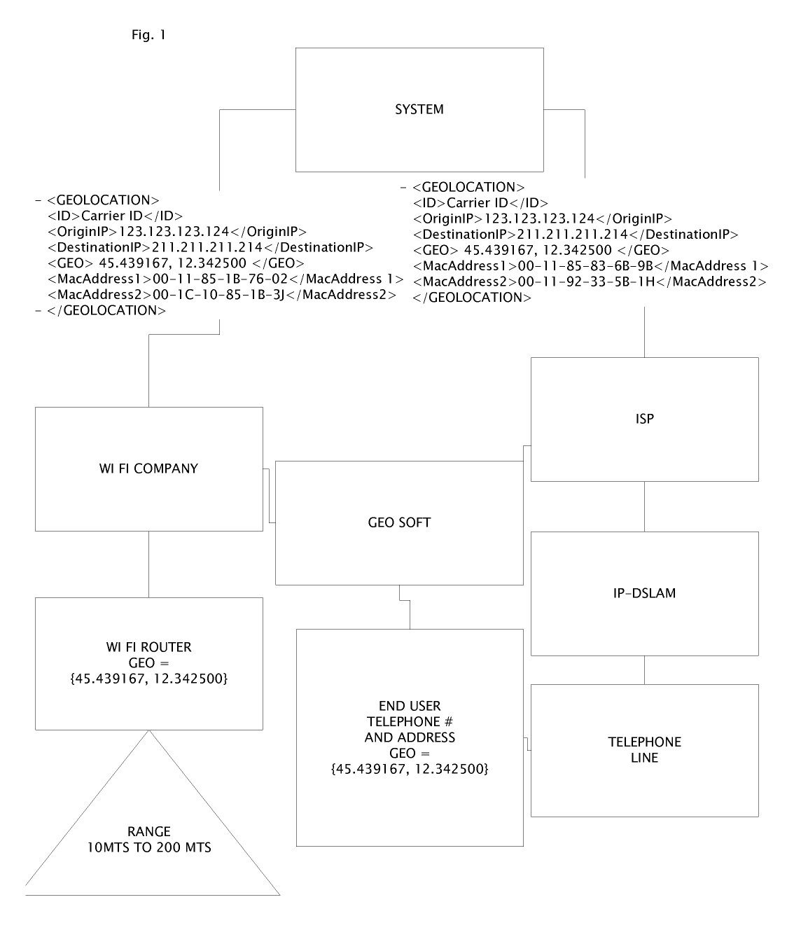

FIG. 2: CELL GEOLOCATION AND DATA TRANSFER using the system Geolocation software to geographically locate their last mile connections—antennas—.

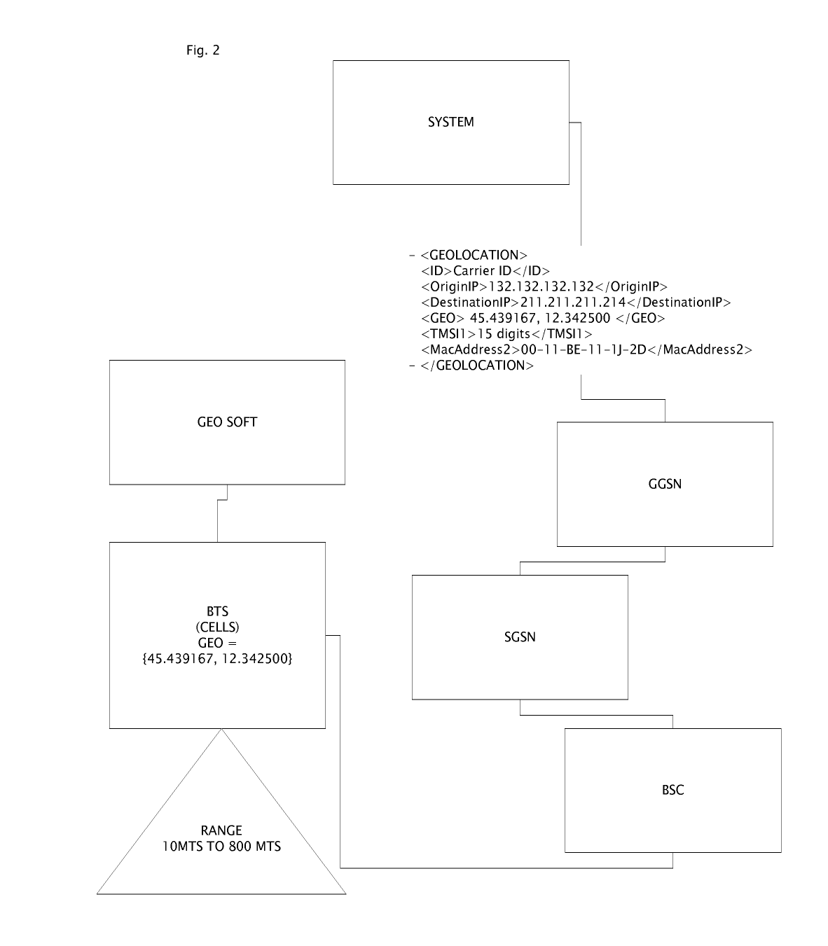

FIG. 3: MAC ADDRESS PAIR

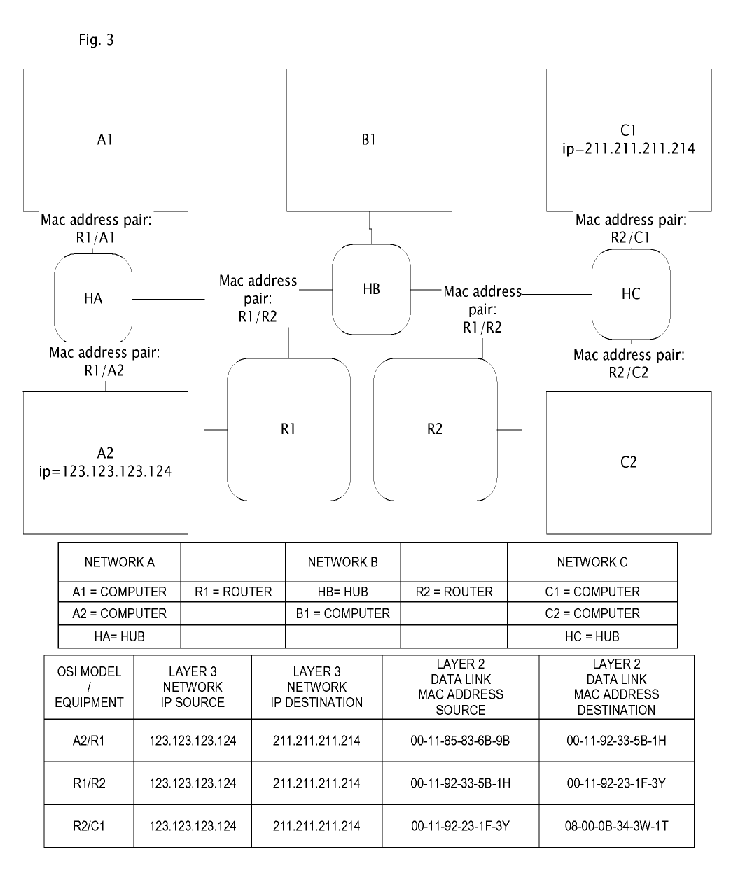

The figure shows the communication—and packet data route—between computer A2 and computer C1. The data package route shows the way physical addresses change on each router hops. Logical addresses remain without changes through the entire communication.

FIG. 4: WEB SERVICE UPLOAD—DATA CARRIER COMPANIES

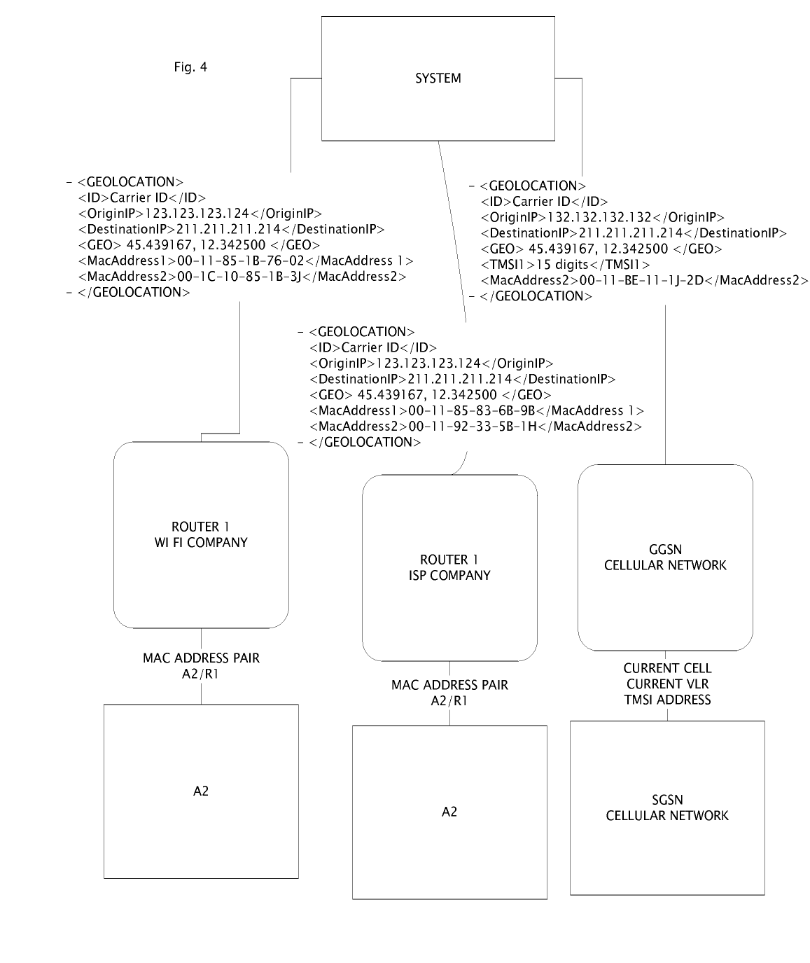

The figure shows the way each system—telephone, Wi Fi and Cellular network—communicates their data to the system.

FIG. 5: FIRST ROUTER METHOD

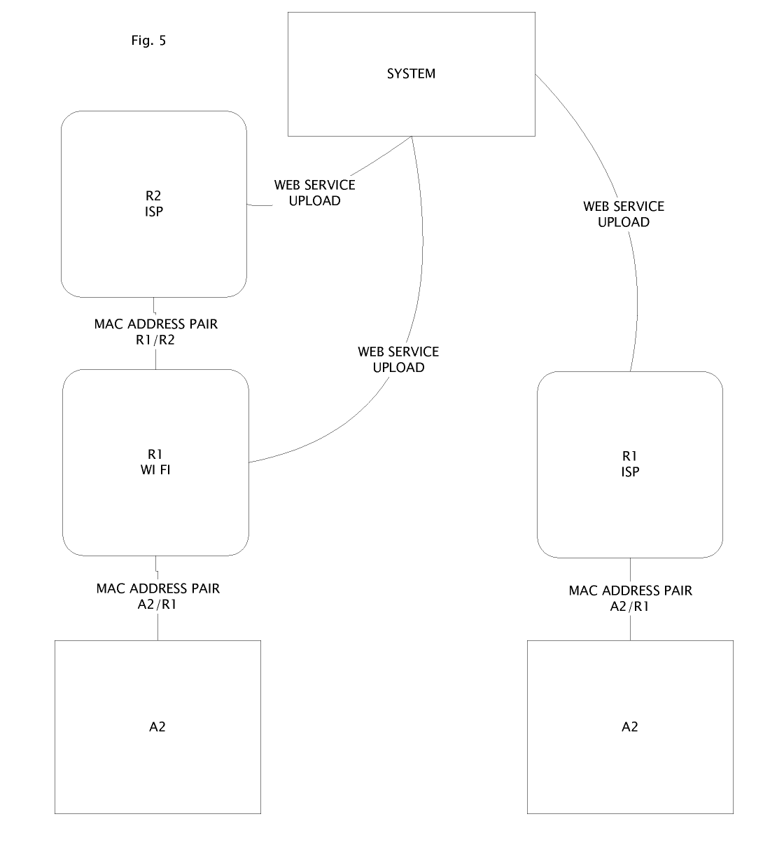

Based on the technical characteristics of the Internet, the physical address could only be provided by data carrier companies with the geographic location of their last mile connections. The system takes in consideration only the first pair of physical MAC address transmitted in a communication between computers. This information is only available for the first router that receives the package from the origin computer.

FIG. 6: WEB SERVICES REQUEST—CONTENT PROVIDER COMPANIES

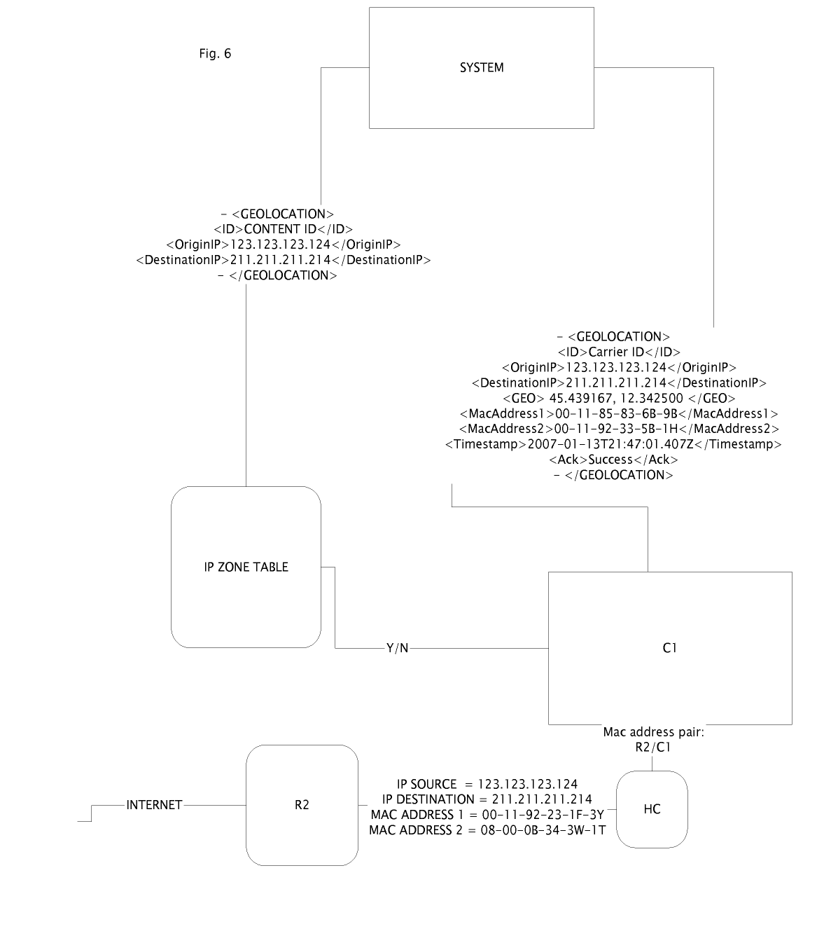

The figure shows the way in which content provider companies request and receive information of geographically located packages.

FIG. 7: PACKET DATA COST ESTIMATION

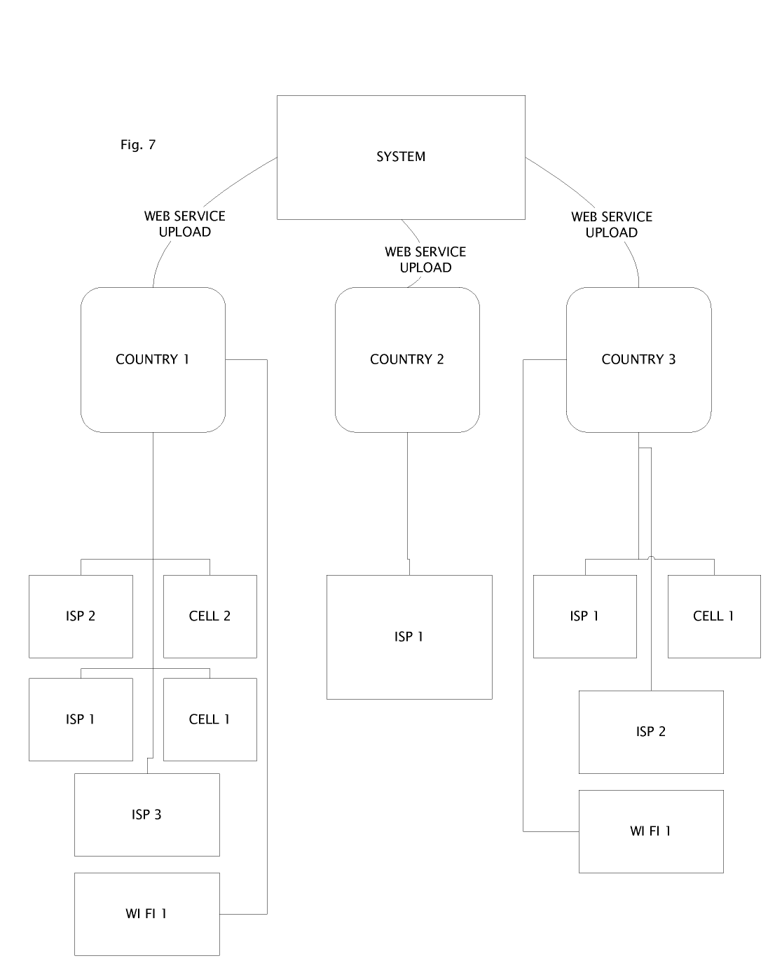

The figure shows the way in which data carrier companies upload the information to the system.

The system analyzes and estimates a cost per package, based on Country ratio information.

FIG. 8: GEO LOCATION REQUEST

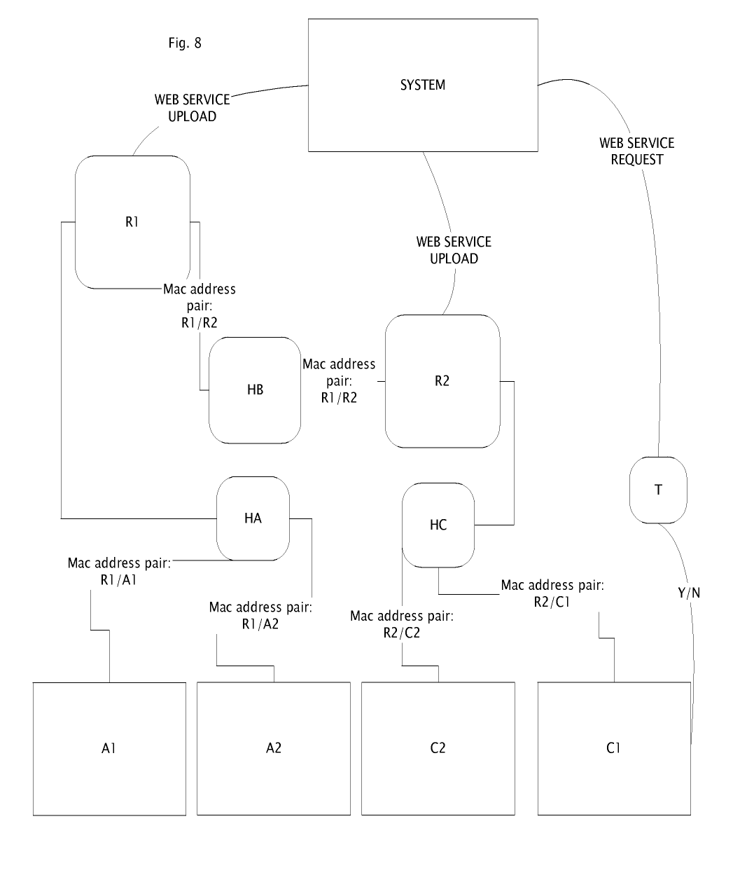

The figure shows the entire system operating. Data carrier companies on one side, Content provider companies on the other, uploading and requesting information.

FIG. 9: CONTENT DELIVERY APPROVAL

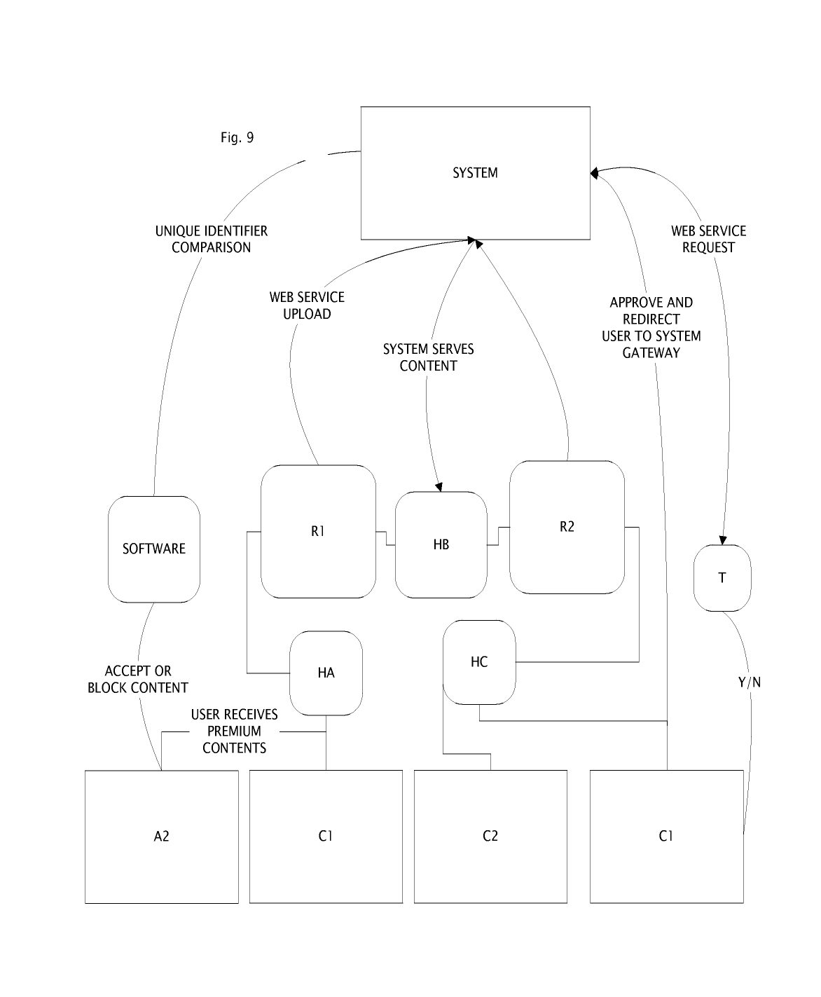

The figure shows the system acting as a content approval platform. Content providers companies affiliated to the Geolocation system detect the user's geographic location and approve/or deny a user's request of content. If approved, that decision is forwarded to the system, Content providers companies redirect users to the system gateway. The system opens a secure connection using TLS protocols and act as a third party between the user and the content provider company. The system compares the unique identifier informed by the content provider company with the unique identifier communicated by the system software. The system matches the physical address communicated with the physical address approved by the content provider company. If it is correct the content is delivered. Otherwise the content is blocked.

### DETAILED DESCRIPTION

The figure one shows the way in which telephone based data carrier companies use the system geo software to localize the fixed lines of their customers in geographic coordinates. When those customers connect to the ISP, companies know the telephone line accessing their network. ISP companies receive the telephone connection at the IP-DSLAM. Data carrier companies make a match using the Username and password of those users and assign a logical public address to surf the internet. Taking in consideration fixed telephone lines are installed in homes and businesses, it is possible for data carrier companies to match that information with the Geolocation software to assign geographic coordinates to those last mile access. Assigning the fixed lines to geographic coordinates, data carrier companies can provide information of the location of particular electronic device accessing to the internet. Wi Fi companies use the geo software to localize their antennas or Wi Fi routers in their networks. All the electronic equipments on those networks carry with W-LAN devices that have attached a unique identifier called MAC address. When these devices detect the signal, they generate a connection and the accessing machine, WI fi router or WI Max antenna, assigns a private IP Address. That information will be communicated to the system. The current range of connectivity of Wi Fi Routers varies from 0 meters up to 10 meters average, with a maximum amount of 100 meters. Wi Max companies and their antennas have a range of connectivity that varies from 0 meters up to a maximum of 10000 meters.

These companies communicate to the system the geographic position of an electronic device requesting information from the internet in a certain period of time. The following information will be uploaded to the system:

Third Layer, Network: Origin IP address and Destination IP address.

Second Layer, Data Link: MAC Address 1 and MAC address 2.

GEO: Geographic coordinates from where this electronic device is requesting information.

CARRIER ID: Affiliate number granted to Data carrier companies. This unique number identifies each company in the system, to assign benefits for the geographically located packages generated and transmitted to the system and paid by Content provider companies.

The figure two shows the way Cellular Network companies use the system geo software to geographically locate their reception antennas, known as BTS. When we analyze Cellular networks, we see that these systems develop their operations using a network of Antennas covering different locations in a certain geographic area, providing mobile devices with access to their networks. At an operating level, those companies assign antennas and their cells to base station subsystems. Through this mechanism cellular networks can manage their flow of packages, voice or data, in their networks. Data packages are channeled towards the Server GPRS support node. These machines manage:
Route and data package transfer.
Location information, current cell and VLR.
Users profiles, IMSI or TMSI.

From the SGSN, data packages go through the Gateway GPRS support node. These machines convert GPRS packages into the appropriate data package format for the internet. GGSN acts as an interface between SGSN and external networks such as IP networks or radio networks.

The system accepts identifier mobile subscriber identity or Temporary mobile subscriber identity information from Cellular companies. Each company will decide which information they want to transfer to the system. Most of carriers prefer to communicate information using Temporary mobile subscriber identity information to protect unique identifiers. In the case of Cellular networks, the system takes into consideration the identifier mobile subscriber identity or Temporary mobile subscriber identity information as the first unique identifier in the pair communicated to our system. The system will receive as the pair of unique identifiers, the Temporary mobile subscriber identity information and the MAC address 2 of the first computer acting as router of packages. These companies communicate to the system the geographic position of an electronic device requesting information from the internet in a certain period of time. The following information will be uploaded to the system:

Third Layer, Network: Origin IP address and Destination IP address.

Second Layer, Data Link: identifier mobile subscriber identity or Temporary mobile subscriber identity 1 and MAC address 2.

GEO: Geographic coordinates from where this electronic device is requesting information.

CARRIER ID: Affiliate number granted to Data carrier companies. This unique number identifies each company in the system, to assign benefits for the geographically located packages generated and transmitted to the system and paid by Content provider companies.

The figure three shows the communication, and packet data route, between computer A2 and computer C1. The data package route shows the way physical addresses changes on each router hops. Logical addresses remain without changes through the entire communication

Using the Open Systems Interconnection Basic Reference Model, OSI Model, to explain the technical side, in a communication between two machines:

The Third Layer, network: will be responsible for assigning IP Addresses, Logical Addresses, to the data packages being part of the connection.

The Second Layer, Data Link: will be responsible for communicating physical addresses of the related machines.

These are only a few functions of each layer, but in these functions lies the explanation and logic of the system.

Data packages communicating machines located in different LANs maintain at a layer network, the same pair of logical address, Origin IP source and Destination IP source, from one computer to the other. On the other hand, at a layer Data Link, physical addresses pairs will be modified on each Hop that the data package performs on each router.

Consequently, destination machines will know the logical address of origin devices but the physical layer of the last router. The only machine that determines the first pair of physical unique identifier, such as MAC address, will be the first router connecting with the origin computer.

The figure shows computer A2 with a logical address 123.123.123.124 and MAC address number 00-11-85-83-6B-9B communicating to the computer C1 on network C. Computer C1 shows Destination IP Address 211.211.211.214 with the MAC address 08-00-0B-34-3W-1T.

Logical addresses remain with the same numbers through the entire communication route, but physical addresses changes with the hop on each router. From R1 to R2 MAC address number 1 will be 00-11-92-33-5B-1H and MAC address number 2 will be=00-11-92-23-1F-3Y. From R2 a C1 MAC address number 1 will be=00-11-92-23-1F-3Y and MAC address number 2 will be=08-00-0B-34-3W-1T. As we observed, level 3—logical addresses—maintain same numbers through the entire connection, but at level 2—physical addresses—change on each hop. Consequently, destination computers only know the logical address of an origin computer requesting information, but not the physical address. This figure shows the technical explanation of this situation. The figure four shows the way in which each system uploads the information to the system. Telephone connection data carrier companies and Wi Fi companies transmitted:

E.G.:—<GEOLOCATION>

<ID>Carrier ISP ID</ID>0 Affiliate number granted to Data carrier companies. This unique number identifies each company in the system, to assign benefits for the geographically located packages generated and transmitted to the system and paid by Content provider companies.

<OriginIP>123.123.123.124</OriginIP> being the third layer—Network—

<DestinationIP>211.211.211.214</DestinationIP> Third layer—Network—

<GEO>45.439167, 12.342500</GEO> Geographic coordinates from where this electronic device is requesting information.

<MACAddress1>00-11-85-83-6B-9B</MACAddress1> Second Layer—Data Link—

<MACAddress2>00-11-92-33-5B-1H</MACAddress2> Second Layer—Data Link—

—</GEOLOCATION>

Cellular network companies upload the following information:

E.G.:—<GEOLOCATION>

<ID>Carrier CELL ID</ID> Affiliate number granted to Data carrier companies. This unique number identifies each company in the system, to assign benefits for the geographically located packages generated and transmitted to the system and paid by Content provider companies.

<OriginIP>123.123.123.124</OriginIP> Third layer—Network—

<DestinationIP>211.211.211.214</DestinationIP> Third layer—Network—

<GEO>45.439167, 12.342500</GEO> Geographic coordinates from where this electronic device is requesting information.

<IMSI-TMSI1>15 digits</IMSI-TMSI1> The unique identifier used by mobile devices on a Cellular network connection. Each company decides if they communicate the IMSI or TMSI of customer's devices to the system.

<MACAddress2>00-11-BE-11-1J-2D</MACAddress2> Second Layer—Data Link—

—</GEOLOCATION>

The way the Internet works nowadays, data carrier companies, if they geographically locate their last mile connections, can detect and determine the physical address of an electronic device requesting information as appears on figure five. Only data carrier companies being the first router will determine the geo location of electronic devices with network functionalities requesting information and connecting to the Internet, with a precision of geographic coordinates. Geolocation can be made using only the logical address plus the geo location provided by the Data Carrier Company, but the possibility to have the physical address makes it possible to determine if that it is the first router in the network. The system will compare all the information provided by different networks, if a router communicates as the first MAC address a unique identifier communicated by another router as the second MAC address, our system will understand that the second one is the very first router in that route between the origin machine and the destination machine. First example: The Origin computer connects through a direct connection to an ISP. The system receives the following information:

ISP:

<ID>Carrier ISP ID</ID> Affiliate number granted to Data carrier companies. This unique number identifies each company in the system, to assign benefits for the geographically located packages generated and transmitted to the system and paid for by Content provider companies.

<OriginIP>123.123.123.124</OriginIP> Third layer—Network—

<DestinationIP>211.211.211.214</DestinationIP> Third layer—Network—

<GEO>45.439167, 12.342500</GEO> Geographic coordinates from where this electronic device is requesting information

<MACAddress1>00-11-85-83-6B-9B</MACAddress1> Second Layer—Data Link—

<MACAddress2>00-11-92-33-5B-1H</MACAddress2> Second Layer—Data Link—

—</GEOLOCATION>

The ISP Company uploads the information. The system estimates that the company has the first pair of MAC addresses and pays to the Data Carrier Company for the geographically located package, if it is purchased by the destination content company.

Second example: The Origin computer connects first to a Wi Fi router of a community Wi Fi Company and this router makes the connection to the ISP. The system receives the following information:

WI FI:

<ID>Carrier WI FI ID</ID> Affiliate number granted to Data carrier companies. This unique number identifies each company in the system, to assign benefits for the geographically located packages generated and transmitted to the system and paid by Content provider companies.

<OriginIP>123.123.123.124</OriginIP> Third layer—Network—

<DestinationIP>211.211.211.214</DestinationIP> Third layer—Network—

<GEO>45.439167, 12.342500</GEO> Geographic coordinates from where this electronic device is requesting information

<MACAddress1>00-11-85-83-6B-9B</MACAddress1> Second Layer—Data Link—.

Note: Connecting to the Wi Fi Router, but using the Ethernet Port.

<MACAddress2>00-1C-10-85-1B-3J</MACAddress2> Second Layer—Data Link—

—</GEOLOCATION>

ISP 1:

<ID>Carrier ISP ID</ID> Affiliate number granted to Data carrier companies. This unique number identifies each company in the system, to assign benefits for the geographically located packages generated and transmitted to the system and paid by Content provider companies.

<OriginIP>123.123.123.124</OriginIP> Third layer—Network—

<DestinationIP>211.211.211.214</DestinationIP> Third layer—Network—

<GEO>45.439167, 12.342500</GEO> Geographic coordinates from where this electronic device is requesting information

<MACAddress1>00-1C-10-85-1B-3J</MACAddress1> Second Layer—Data Link—

<MACAddress2>00-11-92-33-5B-1H</MACAddress2> Second Layer—Data Link—

—</GEOLOCATION>

The Wi Fi community company and the ISP Company upload their information to the system. The system compares the pair of MAC addresses for a package with the same logical addresses, detecting that the first MAC address communicated by the ISP Company is the second MAC address communicated by the Wi Fi community company.

The system assumes that the real first pair of MAC addresses belongs to the Wi Fi Community company and paid for the geographically located package of information to this company.

The figure six shows the way Content provider companies receive from the Internet, data packet from their customers. Content provider companies receive logical address but not physical address of the origin computer. The system offers content provider companies, with high traffic volume, a table with IP ranges, based on country affiliations that they made. Subscribing to a country means to accept the cost per package estimated by the system. If the origin logical address received by the content provider companies doesn't belong to a Country of affiliation, the Web services response will be “Not part of your affiliate zone”. On the other hand, if the logical address belongs to a country where the content company was affiliated, the system will provide the information of Geographic localization of the origin electronic device.

The content company will request to the system the following information using the origin IP address.

—<GEOLOCATION>

<ID>CONTENT ID</ID> Affiliate number granted to Content provider companies. This unique number identifies each company in the system, to charge them for each geographically located package generated and transmitted to the system by data carrier companies

<OriginIP>123.123.123.124</OriginIP> Third layer—Network—

<DestinationIP>211.211.211.214</DestinationIP> Third layer—Network—

—</GEOLOCATION>

The system response to content provider companies providing them with the geographic location of the electronic Device requesting the information.

—<GEOLOCATION>

<ID>Carrier ID</ID> Affiliate number granted to Data carrier companies. This unique number identifies each company in the system, to assign benefits for the geographically located packages generated and transmitted to the system and paid by Content provider companies.

<OriginIP>123.123.123.124</OriginIP> Third layer—Network—

<DestinationIP>211.211.211.214</DestinationIP> Third layer—Network—

<GEO>45.439167,12.342500</GEO> Geographic coordinates from where this electronic device is requesting information

<MACAddress1>00-11-85-83-6B-9B</MACAddress1> Second Layer—Data Link—

MAC address of the origin device

<MACAddress2>00-11-92-33-5B-1H</MACAddress2> Second Layer—Data Link—

MAC address of the first router

<Timestamp>2007-01-13T21:47:01.407Z</Timestamp> the upload time of the geographically located information.

<Ack>Success</Ack> the request was successful

—</GEOLOCATION>

The figure seven shows the way data carrier companies upload the information to the system.

The system will assign data carrier companies to a rate scale based on the registration information and daily operations performed by these participants. The rate scale assigned to a company will depend on:
Amount of GB transmitted per month, where more volume means to receive more money.
Market share based on IP address: the relation between the amount of IP addresses that the Data Carrier company has, compared with the total amount of IP addresses from the same location uploaded by data carrier companies affiliate to the system in that place. Where more technological infrastructures means to receive more money.
Market Share MAC Address: the relation between the amount of MAC addresses that the Data Carrier Company transmitted to the system in a certain period of time, compared with the total amount of MAC addresses transmitted from the same location uploaded by data carrier companies affiliate to the system in that place in the same moment. Where more unique devices transmitted, receives more money.
Range precision: the range precision that this Data Carrier Company shows based on the selected method of connection. Where more precise geographic location transmitted to the system means to receive more money.

The figure eight shows the entire system operating. Data carrier companies on one side, Content provider companies on the other, uploading and requesting information. Router 1 uploads the information of the data package generated by computer A2 with the respective pair of physical and logical addresses. On the other side, computer C1 receives data packet of information generated by computer A2 and make a call to the system to know the geographic location of that origin computer. Through that information, computer C1 customizes the information for the particular geographic area where computer A2 is located.

The figure nine shows the system acting as a content approval platform. Users enrolled in this particular system, allow the system software to manage permissions. This software operates independently from the geo location system. But the Geolocation system is the one that informs the content provider company of the physical address of the requestor device to be approved based on his geographical location. Content providers companies affiliated with the Geolocation system detect the user geographic location and approve/or deny a user request of content. If approved, that decision is forwarded to the content approval system, Content providers companies redirect users to the content approval system gateway. The system opens a secure connection using TLS protocols and act as a third party between the user and the content provider company. The system proceeds to handshake with software located at user's computers. Client sends a clienthello message. This message specifies TLS Protocol and other specifications. The system server sends a serverhello message informing compression method, protocol version plus other specifications. The server requests a certification from the client based on application number and other information such as physical /logical address on that connection to the internet. The system compares the unique identifier informed by the content provider company with the unique identifier communicated by the system software. On the other hand, users with the system software of content delivery installed will be transmitting the physical/logical addresses of their electronic devices to the content approval system. The content approval system matches the physical address communicated, with the physical address approved by the content provider company. If it is correct the content is delivered. Otherwise the content is blocked. Client responds with the information. Client starts all communications encrypted from that moment on.

What is claimed is:

1. A computer implemented method of electronic device geolocation comprising: a system to determine the geographical location of an origin electronic device with networking capabilities based on the information provided by a data carrier company.

2. The method of claim 1, wherein each data carrier company assigns to geographic coordinates their last mile connections and transmits data packet information to the system.

3. The method of claim 1, wherein the system compares the information provided by a data carrier company taking into consideration the pair of unique identifiers for a package with the same logical addresses transmitted by all routers from carriers affiliated to the system, detecting which one was the first router with direct communication with the origin unique identifier.

4. The method of claim 3, wherein the determination of the geographical location of an origin electronic device, the system identifies which one is the first router in the communication between two computers, based on the information handled by the first router, being the only device in the network with access to the first pair of physical addresses while all other routers receiving the data package will have the physical addresses of intermediate machines operating in the network.

5. A computer implemented method ranking last mile connections of data carrier companies, comprising a system that assigns data carrier companies to a rate scale based on the registration information and daily operations performed by these participants, wherein the determination identifies:
a weighting factor based on the amount of gb transmitted per month that they generate on daily operations, paying more money for greater volumes;
a weighting factor based on the relationship between the amount of ip addresses that the data carrier company generate on daily operations, compared with the total amount of ip addresses from the same location uploaded by data carrier companies affiliate to the system in that place;
a weighting factor based on the relation between the amount of unique identifiers, such as mac addresses, that the data carrier company transmitted to the system generated on daily operations, compared with the total amount of unique identifiers, such as mac addresses, transmitted by data carrier companies affiliate to the system in that place in the same moment; and
a weighting factor based on the range precision that this data carrier company shows on daily operations based on the selected method of connection.

6. A computer implemented method to act as a content delivery approval platform comprising a system where affiliated content providers companies approve or deny a user request of content based on the geographical location detected, redirecting approved users to system gateways in order to serve content using tis protocols, to final consumers.

7. The method of claim 6, wherein the assigning includes a system that approves or denied access to the content by matching a unique identifier informed by a content provider company, with the unique identifier communicated by software located at user computer, to approve content delivery.
